(19) United States
(12) Patent Application Publication
(10) Pub. No.: US 2011/0085191 A1
(43) Pub. Date: Apr. 14, 2011

(54) IMAGE PROCESSING APPARATUS AND IMAGE PROCESSING METHOD

(75) Inventor: Jun Takato, Shizuoka-ken (JP)

(73) Assignees: KABUSHIKI KAISHA TOSHIBA, Tokyo (JP); TOSHIBA TEC KABUSHIKI KAISHA, Tokyo (JP)

(21) Appl. No.: 12/904,100

(22) Filed: Oct. 13, 2010

Related U.S. Application Data
(60) Provisional application No. 61/251,550, filed on Oct. 14, 2009.

(51) Int. Cl. G06F 3/12

(52) U.S. Cl. 358/1.13

(57) ABSTRACT

An image processing apparatus includes: a data acquisition unit which acquires image data as a processing target; an image processing unit which carries out image processing with a processing content based on setting information, to the image data; plural output processing units which output the image data processed by the image processing unit, by different output methods from each other; a setting information acquisition unit which acquires the setting information; a determination unit which determines an output method that is selectable for the image data to which the processing with the setting content indicated by the setting information acquired by the setting information acquisition unit is carried out, of the plural output methods used by the plural output processing units; and a selection candidate display unit which displays a list of information indicating the output method that is determined as selectable by the determination unit.

### CROSS-REFERENCE TO RELATED APPLICATION(S)

This application is based upon and claims the benefit of priority from: U.S. provisional application 61/251,550, filed on Oct. 14, 2009; the entire contents all of which are incorporated herein by reference.

### FIELD

Embodiments described herein relate generally to a technique that enables contribution to improved convenience in the selection of an output destination in the case of outputting an image processed by an image processing apparatus.

### BACKGROUND

Conventionally, in the case of outputting an image to which predetermined processing is carried out by an image processing apparatus by various output methods, for example, facsimile transmission and email transmission, the output method used in determined in advance before carrying out the predetermined processing to the image.

In the conventional image processing apparatus, when the user wants to carry out predetermined processing to a certain image and then to output the processed image, the user selects in advance a method for outputting the processed image data, for example, from email transmission, FTP (file transport protocol) transmission, data transmission to a shared storage space on a server, and the like.

However, the image quality of the image that is ultimately outputted may vary depending on the output method for the image. Also, depending on the selected output method, restrictions may be imposed on the output in accordance with the state of the processed image data.

For example, when an image of unknown size is transmitted via email, the image file cannot be transmitted via email if the size of the image file is too large.

In this case, in order to transmit the image via email, the image must be re-captured by a scanner. In addition, a file acquired with the output method set to “email transmission” cannot be outputted via “FTP transmission”.

As described above, in the conventional image processing apparatus, the image quality and other properties of the output results cannot be checked unless the image is actually outputted using the output method selected in advance. The problems with such an image processing apparatus include: a reduction in work efficiency due to rework such as re-input work for the document file; and unnecessary cost caused by re-output using a different output method after the image is once outputted.

### DESCRIPTION OF THE DRAWINGS

FIG. 1 is a perspective view showing an image processing apparatus according to an embodiment.

FIG. 2 is a functional block diagram for explaining the image processing apparatus.

FIG. 3A is a conceptual view conceptualizing an operation that functions in the image processing apparatus.

FIG. 3B is a conceptual conceptualizing an operation that functions in the image processing apparatus.

FIG. 4 shows one example of the XML description for allowing a control unit 105 of the image processing apparatus to execute the processing shown in FIGS. 3A and 3B.

FIG. 5 shows one example of the XML description corresponding to an extended part used to describe an additional instruction given by the user to execute an additional function after completion of “Output 2”.

FIG. 6 shows examples of the parameters that do not allow the execution of the Extend Function if the input method for document data is the scanning function of the image scanning unit 102.

FIG. 7 shows an example of a user interface screen that is displayed when the image processing apparatus 100 executes an Extend Function.

FIG. 8 shows an example of a user interface screen that is displayed when the image processing apparatus 100 executes the Extend Function.

FIG. 9 shows an example of a user interface screen that is displayed when the image processing apparatus 100 executes the Extend Function.

FIG. 10 shows an example of a user interface screen that is displayed when the image processing apparatus 100 executes the Extend Function.

FIG. 11 shows an example of a user interface screen that is displayed when the image processing apparatus 100 executes the Extend Function.

FIG. 12 shows an example of a user interface screen that is displayed when the image processing apparatus 100 executes the Extend Function.

FIG. 13 shows an example of a user interface screen that is displayed when the image processing apparatus 100 executes the Extend Function.

FIG. 14 shows an example of a user interface screen that is displayed when the image processing apparatus 100 executes the Extend Function.

FIG. 15 shows an exemplary user interface screen that is displayed when the image processing apparatus 100 executes the Extend Function.

FIG. 16 is a flowchart illustrating the input-output processing for the Extend Function in the image processing apparatus.

### DETAILED DESCRIPTION

In general, according to an embodiment, an image processing apparatus includes a data acquisition unit, an image processing unit, plural output processing units, a setting information acquisition unit, a determination unit, and a selection candidate display unit.

The data acquisition unit acquires image data as a processing target.

The image processing unit carries out image processing with a processing content based on setting information, to the image data.

The plural output processing units output the image data processed by the image processing unit, by different output methods from each other.

The setting information acquisition unit acquires the setting information.

The determination unit determines an output method that is selectable for the image data to which the processing with the setting content indicated by the setting information acquired by the setting information acquisition unit is carried out, of the plural output methods used by the plural output processing units.

The selection candidate display unit displays a list of information indicating the output method that is determined as selectable by the determination unit.

Hereinafter, an embodiment will be described with reference to the drawings.

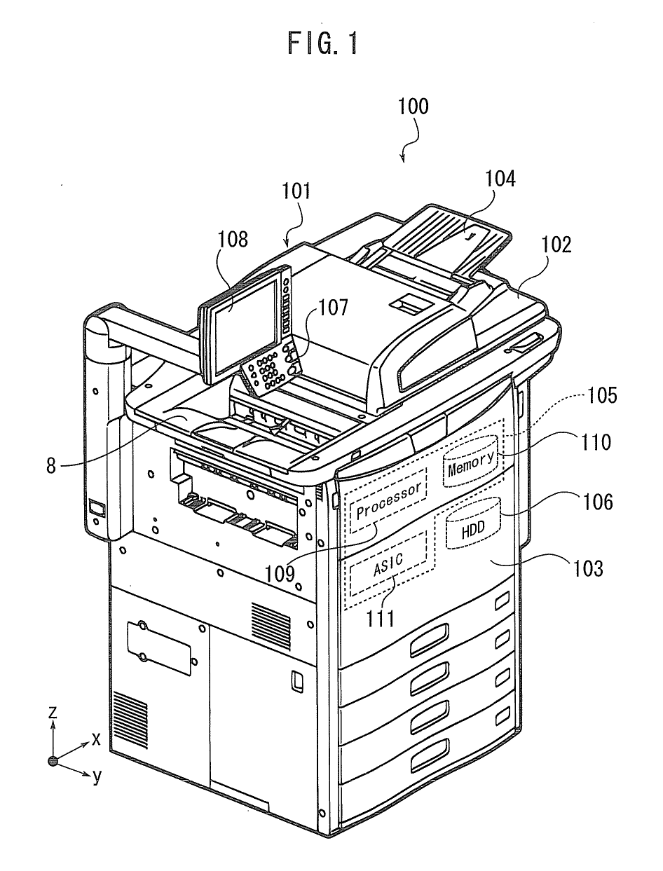

FIG. 1 is a perspective view showing an image processing apparatus according to the embodiment.

The image processing apparatus (or MFP: Multi Function Peripheral) 100 has an automatic document feeder unit 101, an image scanning unit 102, and an image forming unit 103.

The automatic document feeder (ADF) unit 101 has the function of automatically and continuously feeding plural sheets of documents placed on a tray 104 to a predetermined position for document scanning in the image scanning unit 102.

The image scanning unit 102 is disposed in an upper part of the body of the image processing apparatus and scans and reads the image of each sheet document automatically fed by the automatic document feeder unit 101 or the image of a sheet or book document placed on a not-shown document placing table.

The image forming unit 103 forms an image corresponding to image data on a sheet supplied from a paper supply cassette. This image data is, for example, image data of a document scanned by the image scanning unit 102 or image data received from an external device connected to the image processing apparatus 100.

The sheet on which the image is formed by the image forming unit 103 is discharged onto a discharge tray 8.

The image processing apparatus 100 further has a control unit 105, a storage unit 106, an operation unit 107, and a display unit 108.

The functions of the control unit 105 are achieved by a processor 109 (a CPU (Central Processing Unit) or an MPU (Micro Processing Unit)), a memory 110, an ASIC 111, and an operating system (OS). The memory 110 is, for example, a semiconductor memory and includes a ROM (Read Only Memory) that stores control programs for the processor 109 and a RAM (Random Access Memory) that provides a temporary work area to the processor 109. The control unit 105 controls the operation unit 107, the display unit 108, the image scanning unit 102, and the image forming unit 103 according to the control programs and other programs stored in the ROM or the storage unit 106. The control unit 105 further has the function of correcting or enlarging image data.

The storage unit 106 temporarily stores the image data of a document scanned by the image scanning unit 102, the image data acquired from an external device, or other data. The storage unit 106 may be a magnetic storage device such as a hard disk drive, an optical storage device, a semiconductor storage device (such as a flash-memory), or any combination of these storage devices.

The memory 110 may include, in addition to the RAM and the ROM, a DRAM (Dynamic Random Access Memory), an SRAM (Static Random Access Memory), a VRAM (Video RAM), a flash memory, and the like.

The display unit 108 can include, for example, electronic paper, an LCD (Liquid Crystal Display), an EL (Electronic Luminescence) display, a PDP (Plasma Display Panel), a CRT (Cathode Ray Tube), or the like.

The operation unit 107 can include a touch panel, a touchpad, a graphics tablet, a dedicated button, and the like.

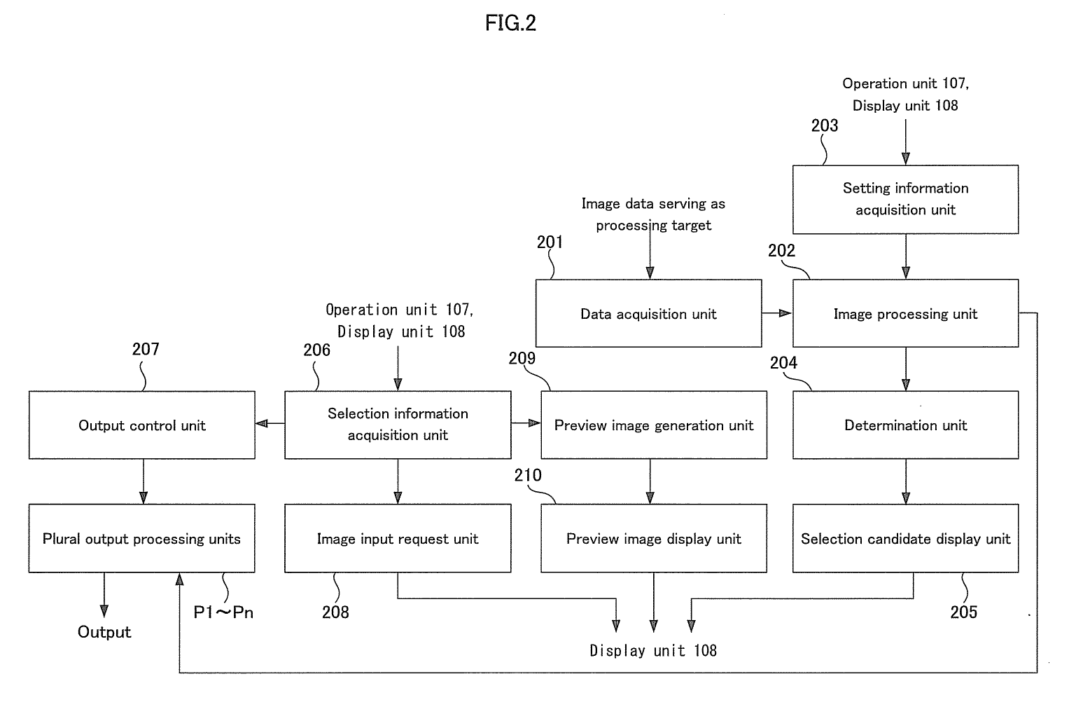

FIG. 2 is a functional block diagram explaining the image processing apparatus 100.

The image processing apparatus 100 includes a data acquisition unit 201, an image processing unit 202, plural output processing units P1 to Pn, a setting information acquisition unit 203, a determination unit 204, a selection candidate display unit 205, a selection information acquisition unit 206, an output control unit 207, an image input request unit 208, a preview image generation unit 209, and a preview image display unit 210.

The data acquisition unit 201 acquires image data as a processing target.

The image processing unit 202 carries out image processing with a processing content based on setting information, to image data. The data generated by the image processing unit 202 is defined as “intermediate output data” in this specification.

Specifically, the “intermediate output data” is internal data that is used in the image processing apparatus immediately before final output data including information that enables the user to decide a final output destination is produced. For example, before the final output data is determined, the “intermediate output data” is processed on the basis of the setting conditions inputted by the user to produce processed data, and the processed data is presented to the user as a preview image.

The plural output processing units P1 to Pn output the image data processed by the image processing unit, by different output methods from each other.

Here, as an “output method”, various data output methods that can be provided in the image processing apparatus are prepared, for example, “print”, “facsimile transmission”, “email transmission”, “data transmission by FTP”, “data saving into a predetermined storage area (Filing, E-filing, SMB)” or the like.

The setting information acquisition unit 203 acquires the setting information.

The determination unit 204 determines an output method that is selectable for the image data to which the processing with the setting content indicated by the setting information acquired by the setting information acquisition unit 203 is carried out, of the plural output methods used by the plural output processing units P1 to Pn.

For example, when the “setting information” acquired by the setting information acquisition unit 203 prescribes the data volume of document data subjected to processing including the content indicated by the setting information, the determination unit 204 determines an output method by which an output can be made in the data volume of the document data to which the processing with the content indicated by the setting information is carried out.

The selection candidate display unit 205 displays, on the display unit 108, a list of information indicating the output methods determined as selectable by the determination unit 204.

The selection information acquisition unit 206 acquires “selection information” indicating which output method is selected from the information indicating the output methods displayed in the list by the selection candidate display unit 205, on the basis of an operation input by the user through the operation unit 107.

The output control unit 207 causes the output processing unit corresponding to the selected output method indicated by the “selection information” acquired by the selection information acquisition unit 206, to output the document data processed by the image processing unit 202.

The image input request unit 208 requests input of the document data after the selection information is acquired by the selection information acquisition unit 206. The selection information acquisition unit 206 acquires the “selection information” indicating which output method is selected in accordance with an operation input by the user, of the output methods displayed in the list by the selection candidate display unit 205.

The preview image generation unit 209 processes the “intermediate output data” according to the setting conditions inputted by the user to generate processed data for a preview image.

The preview image display unit 210 displays the preview image generated by the preview image generation unit 209.

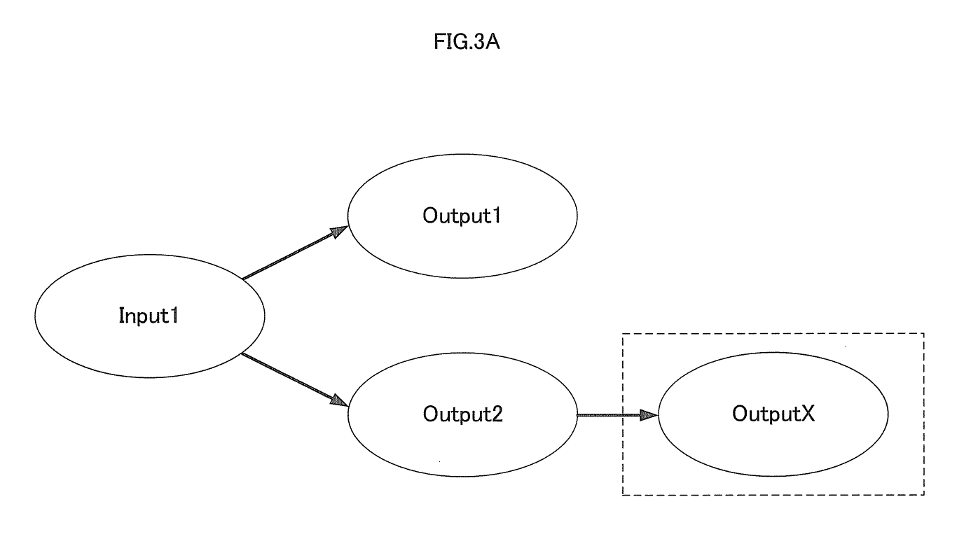

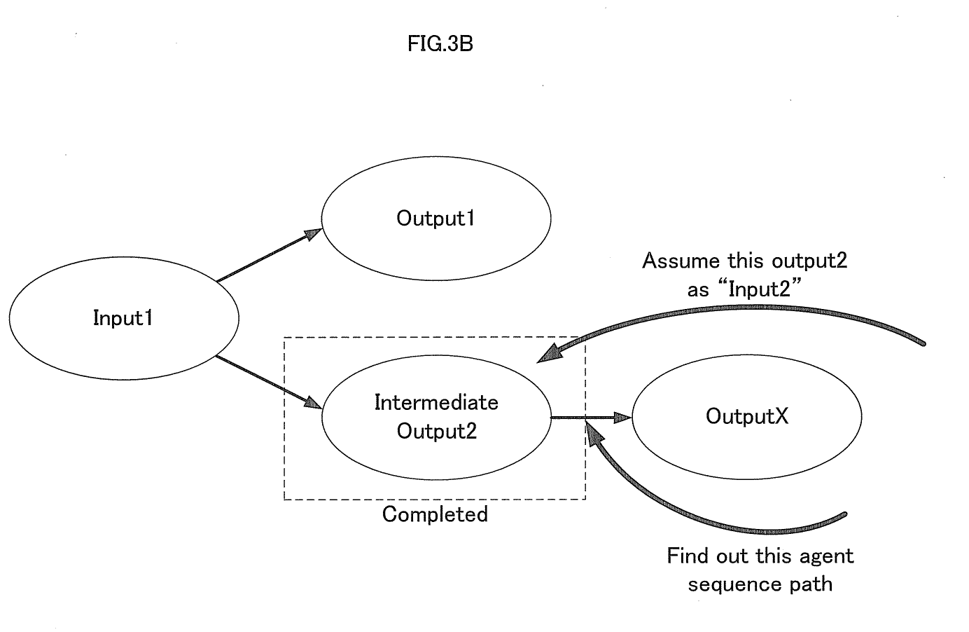

FIGS. 3A and 3B are conceptual views conceptualizing an operation that functions in the image processing apparatus 100.

In the operations shown in FIGS. 3A and 3B, the user intends to cause the image processing apparatus to execute two output functions including “Output 1” and “Output 2”.

The user specifies the output method for “Output 1” in advance. In FIG. 3A, the output method already specified by the user is used for “Output 1”. The user requests the image processing apparatus 100 to execute “Output 2” using one of the output methods included in the apparatus 100 in parallel with “Output 1” or in a processing flow subsequent to “Output 1”. The document data is inputted or acquired with the final output method for “Output 2” unspecified by the user. In the operations shown in FIG. 3B, the acquisition of the document data is started with the output method for “Output 2” unspecified by the user.

In FIG. 3B, “Output 1” simply ends after execution of its function. The output data for “Output 2” in which the output method is unspecified in FIG. 3A is generated as “intermediate output data”. When the user inputs a predetermined parameter, the control unit 105 processes the intermediate output data according to the inputted parameter to generate processed data. After checking the processed data, the user specifies the output method for “Output 2”. The processed data is then processed using the function of “Output 2”. The function of generating intermediate output data and extending the intermediate output data to the output method for Output 2 is referred to as an Extend Function.

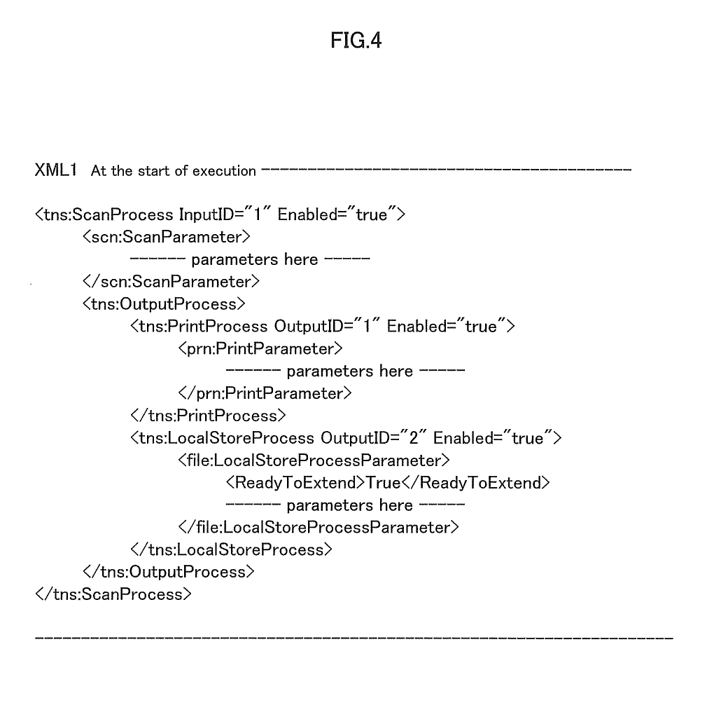

FIG. 4 shows one example of the XML description for allowing the control unit 105 of the image processing apparatus to execute the processing shown in FIGS. 3A to 3B. The program for the XML description is stored, for example, in the memory 110 or the storage unit 106. In the drawings, the document data is acquired by the image scanning unit 102.

As can be seen in the 13^{th} line of the XML description shown in FIG. 4, <ReadyToExtend>True<ReadyToExtend> is described in a command line corresponding to “Output 2” shown in FIG. 3A, thus explicitly showing that there is Output X in the image processing apparatus after Output 2.

Thus, the image processing apparatus understands that the function is not completed at this point and that the apparatus needs to wait for the next function to be executed from the user.

Meanwhile, as can be seen in the 8^{th} line of the XML description shown in FIG. 4,

(1)<ReadyToExtend>True<ReadyToExtend> is not described, or

(2)<ReadyToExtend>false<ReadyToExtend> is described in a command line corresponding to “Output 1” shown in FIG. 3A, thereby notifying the processor 109 that no further function is to be continued for Output 1 and therefore Output 1 is to end.

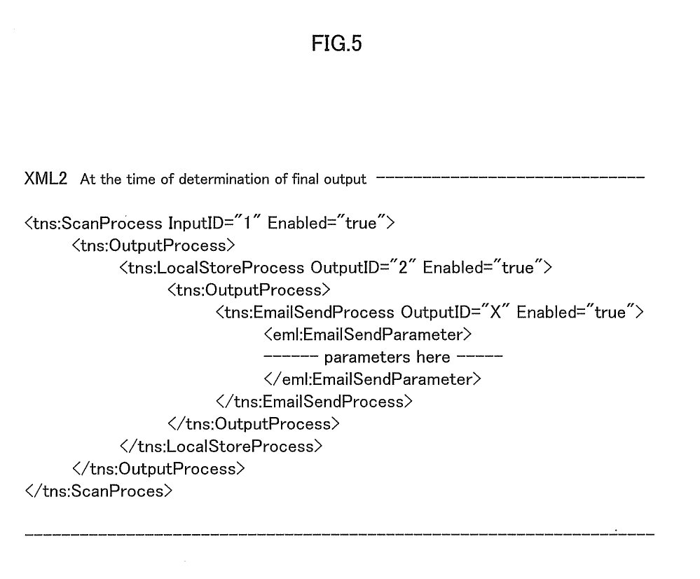

FIG. 5 shows an example of the XML description corresponding to a part extended to describe an additional instruction from the user in order to execute a further function starting at the time point when “Output 2” is completed.

OutputID=“X” (corresponding to “Output X” in FIG. 3A) is given in a lower layer of OutputID=“2” (corresponding to “Output 2” in FIG. 3A). This allows the processor 109 to recognize that “Output X” is extended from “Output 2”.

Next, an example of a table for managing parameters that do not allow the execution of the Extend Function is shown.

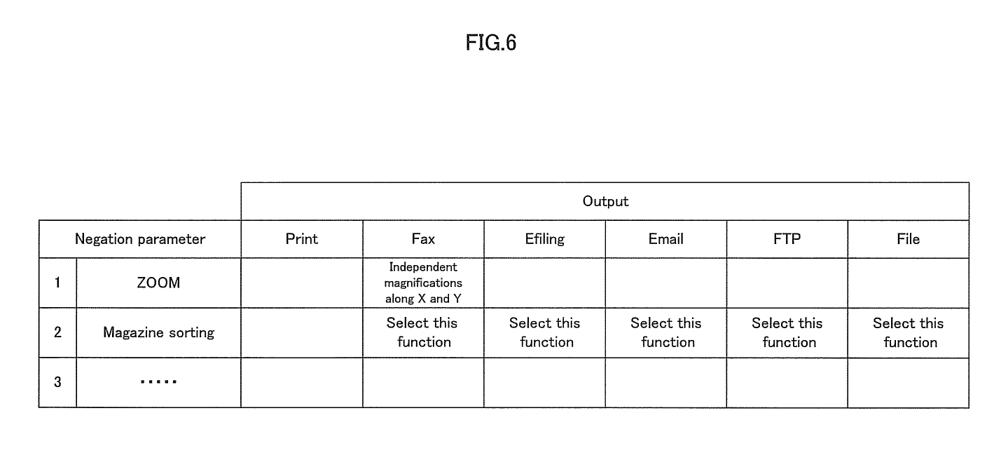

FIG. 6 shows examples of the parameters that do not allow the execution of the Extend Function if the input method for document data is the scanning function of the image scanning unit 102.

For example, negation parameter 1 (Zoom) is used to set magnifications in percent and indicates that image processing for a FAX function cannot be executed when the magnifications of image data along X and Y axes are independently set. Magazine sorting (negation parameter 2) is the function of forming two manuscript images on each of the front and back sides of one sheet such that a center-folded booklet is formed by folding the sheet having the images formed thereon in two at the center. When this function is selected, the order of the pages in the intermediate output data is changed, and the pages are arranged in an order different from the original order. Therefore, when negation parameter 2 (magazine sorting) is selected, the Extend Function cannot be executed using output methods other than Print/Copy due to restrictions from the ASIC and other factors.

The management table is stored in storage means such as the memory 110 or the storage unit 106. In the example shown in FIG. 6, the input method is scanning, but this is not a limitation. Examples of the method of acquiring document data, i.e., the input method, include: acquisition from a file stored in the image processing apparatus 100 in advance (“File” or “Efiling”); acquisition of file data by “polling reception”; and acquisition of document data sent from a printer driver of an external drive such as a personal computer. For example, with the input method for document data by “File”, “Efilling”, or “polling reception”, parameter restrictions that do not allow the execution of the Extend function are determined by the restrictions from the original document data. The data acquired from an input source by “File” or “Efilling” is data acquired using a Scan to File function or data sent from an external device. The preview image of the data stored in the image processing apparatus 100 by “Efiling” can be viewed on a Web browser.

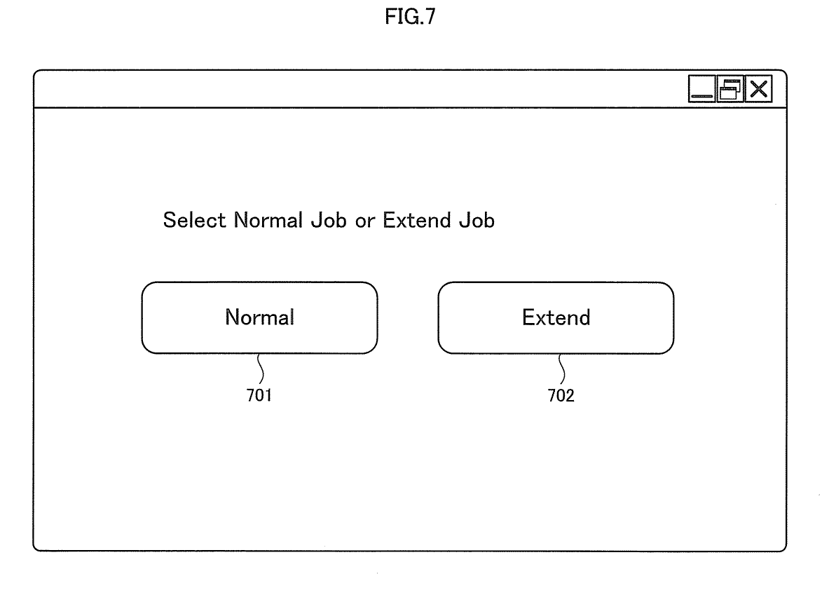

FIGS. 7 to 15 each show an example of a user interface screen displayed on the display unit 108 of the image processing apparatus 100 when the apparatus 100 executes the Extend Function.

The input-output processing in the Extend Function in the image processing apparatus will next be described with reference to FIGS. 7 to 15.

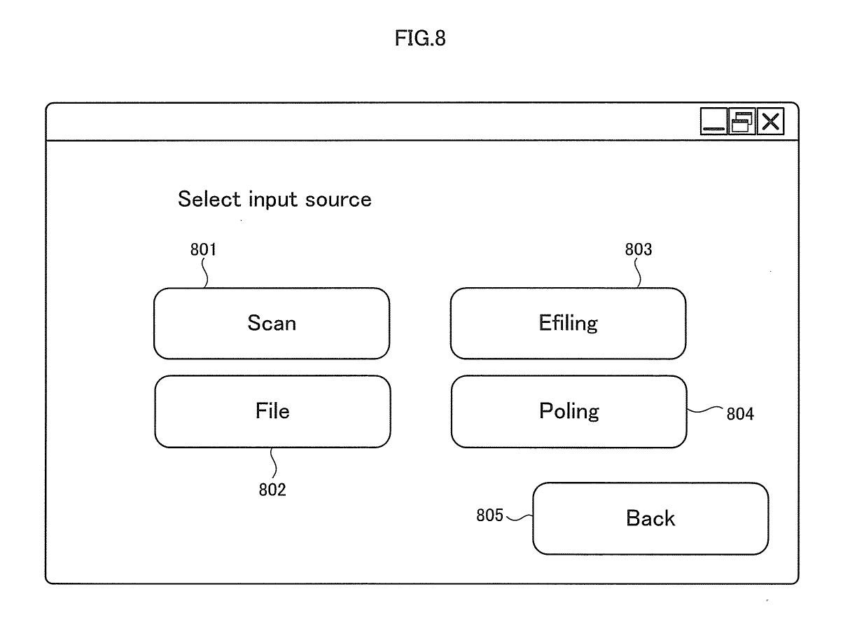

On the screen shown in FIG. 7, the user selects whether to execute a normal job or the job for the Extend Function that is executed without specifying a final output destination. If an Extend icon 702 in FIG. 7 is selected, the screen shown in FIG. 8 is displayed on the display unit 108.

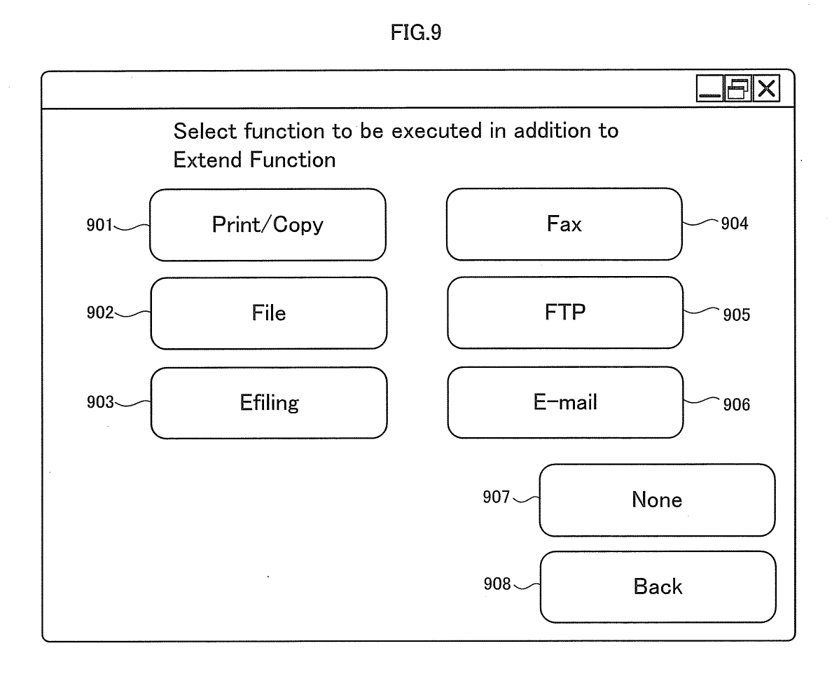

On the screen shown in FIG. 8, the user designates the input source of the document data. More specifically, the user selects, as the input method for the document data, one of a button 801 (scanning), a button 802 (File), a button 803 (Efiling), and a button 804 (polling). When the input source is selected on the screen shown in FIG. 8, the screen shown in FIG. 9 is displayed on the display unit 108. In the following example, scanning (the button 801) is selected as the input source.

On the screen shown in FIG. 9, a function (an output method) performed in parallel with the execution of the External Function or as a sequential process is selected. More specifically, the selected function (corresponding to Output 1 in FIGS. 3A and 3B) is executed before the document data acquired from the input source selected in FIG. 8 is processed according to the output method for the Extend Function. For example, if the user wants to first form the image of the document data on a sheet, then process the document data using a predetermined parameter, and specify the output method for the processed document data, the user selects Print/Copy 901 on the screen shown in FIG. 9. If any function other than the Extend Function is not executed, a button 907 is selected.

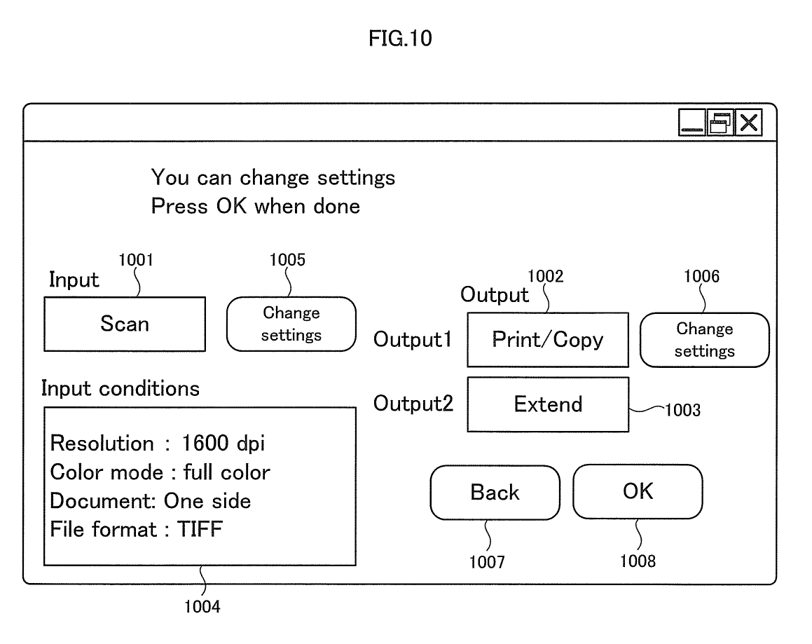

On the screen shown in FIG. 10, the user confirms the input source and the output destination. The input source selected in FIG. 8 is displayed in 1001. The function (output method) selected in FIG. 9 is displayed in 1002. The display in 1003 shows whether or not the Extend Function is set. In this example, Scan is set as the input source, and therefore the input conditions are displayed in 1004. The most general processing conditions (resolution: maximum value, scanning: color, etc.) under which the image processing apparatus 100 can perform processings are set as the default input conditions. To set or change the input conditions and the processing conditions for Output 1, setting buttons 1005 and 1006 are selected. If a button 1007 (Back) is selected, the previous screen appears.

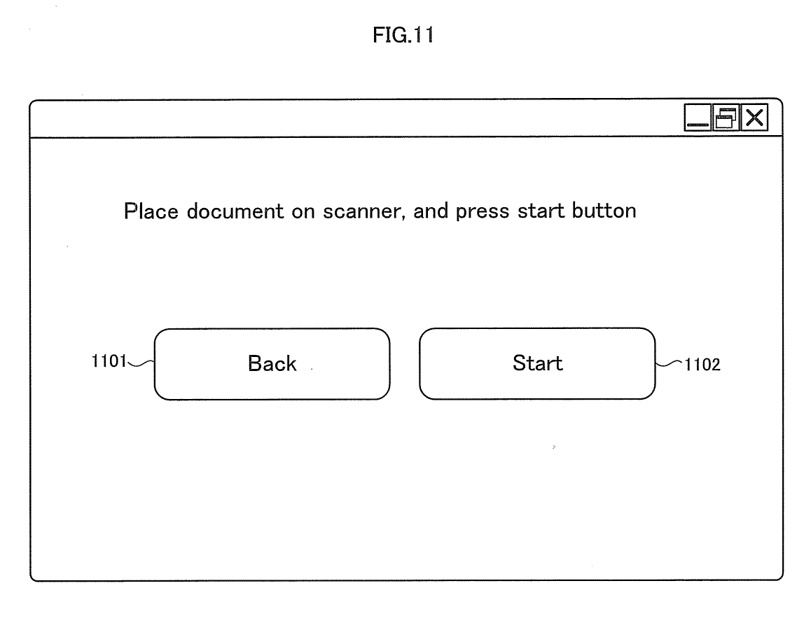

If a button 1008 (OK) in FIG. 10 is pressed, the screen shown in FIG. 11 is displayed on the display unit 108. If the input source is “Scan”, the image processing apparatus 100 requests the user to place an original document on the image scanning unit 102. The user then presses down a button 1102 to submit an instruction for starting the acquisition of the document data, and the control unit 105 acquires the document data according to the input conditions and executes the function (Output 1) selected in FIG. 9. In this example, a copy function is executed according to the setting conditions set in FIG. 10. In addition, the control unit 105 generates the intermediate output data for the Extend Function.

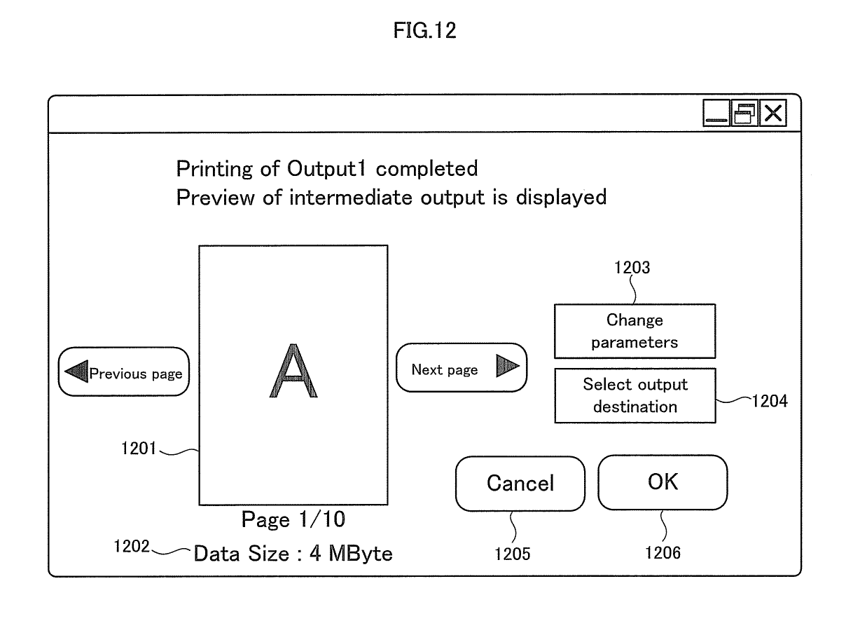

The control unit 105 then displays a preview image 1201 for the generated intermediate output data on the display unit 108, as shown in FIG. 12. The size of the intermediate output data is displayed in 1202. Reference numeral 1203 represents a parameter change button; 1204 represents an output selection button; 1205 is a cancel button; and 1206 is an OK button.

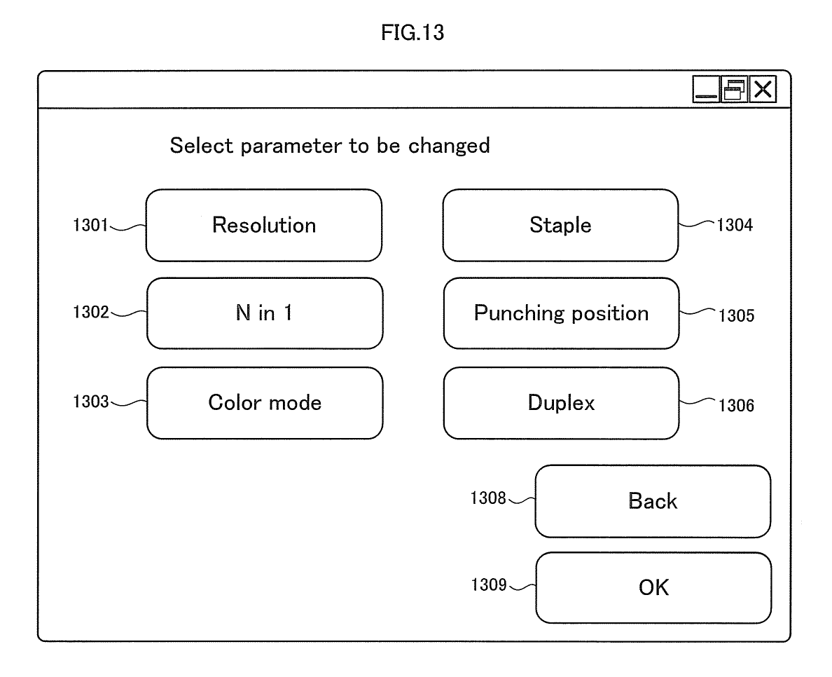

The parameter change button 1203 is used to change the parameters for the intermediate output data. If the parameter change button 1203 is pressed, the screen shown in FIG. 13 is displayed.

If the user wants to change a parameter for the intermediate output data, the user selects this parameter on the screen shown in FIG. 13. For example, the resolution is set on a resolution changing screen that is displayed when a resolution button 1301 is selected.

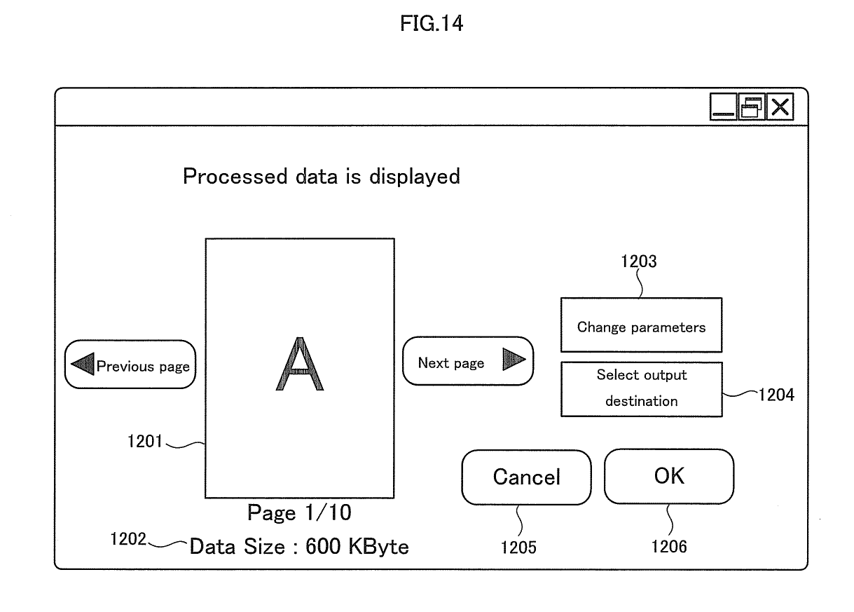

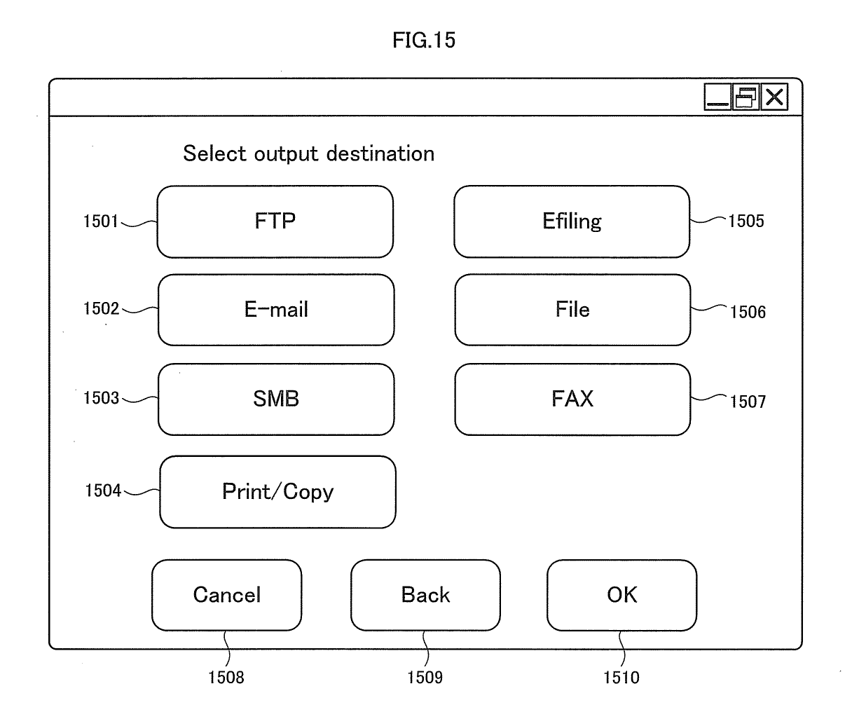

If the parameter for the resolution is changed to a value smaller than the resolution of the document data scanned by the scanner, the control unit 105 generates processed data from the intermediate output data according to the changed resolution. The original intermediate output data is stored in the storage unit 106. FIG. 14 shows a display on the display unit 108 on which the processed data that, because of the change in resolution, has a smaller size than that of the intermediate output data is displayed as a preview image. In FIG. 14, the user checks the size and image of the processed data to determine whether or not final output processing is executed. Then if the output selection button 1204 is pressed, a screen 1500 used to select the final output method (output function) for Output 2 is displayed (FIG. 15). In this example, the user selects Email (a button 1502) as the final output destination on the screen 1500. If the OK button 1206 is pressed after the final output method for Output 2 is set, the control unit 105 processes the processed data using an e-mail function. As described above, the output for Output 1 is executed, and the Extend Function that extends the intermediate output data to the output method for Output 2 is also executed.

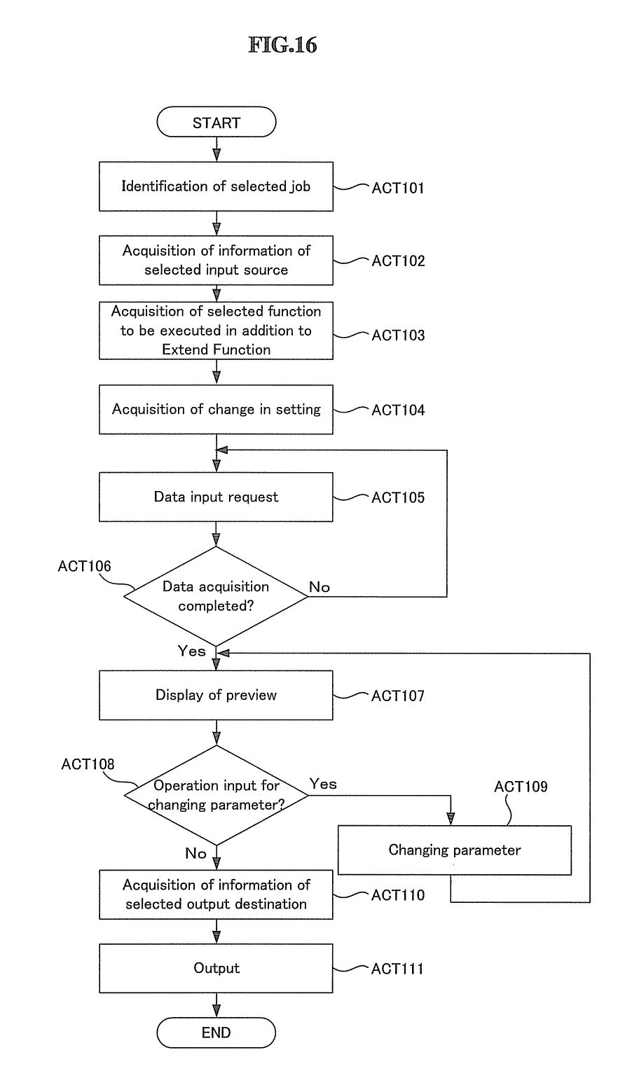

Next, the Extend Function used in the image processing apparatus will be described using a flowchart. FIG. 16 is a flowchart that describes the input-output processing in the Extend Function in the image processing apparatus.

The control unit 105 identifies whether the selection made by the user through operation input into the operation unit 107 is the Normal Job or Extend Job (ACT 101). This selection is made on the user interface screen shown in FIG. 7 that is displayed on the display unit 108.

The control unit 105 acquires the information of the Job selected in ACT 101 and then displays, on the display unit 108, the user interface screen (FIG. 8) used for the selection of the input source of the target document data.

The control unit 105 acquires the information of the operation input by the user on the screen shown in FIG. 8 and identifies the selected input source (ACT 102).

The control unit 105 acquires, through the operation unit 107, the information of a selected function that is selected on the user interface screen shown in FIG. 9 and is to be executed in addition to the Extend Function (ACT 103).

Next, the control unit 105 receives, through the operation unit 107, the operation input for a change in setting made by the user on the user interface screen shown in FIG. 10 (ACT 104).

The control unit 105 displays, on the display unit 108, a screen used to request input of the document data serving as the processing target (ACT 105).

After completion of the acquisition of the data serving as the processing target (YES in ACT 106), the control unit 105 displays, on the display unit 108, a preview image as intermediate output based on the settings (ACT 107).

If the control unit 105 receives, through the operation unit 107, a change in a processing setting parameter after the preview image is displayed (YES in ACT 108), the control unit 105 changes the setting parameter (ACT 109). The change in the setting parameter is stored in, for example, the storage unit 106.

If the control unit 105 does not accept any change in a processing setting parameter through the operation unit 107 (NO in ACT 108), the control unit 105 acquires, through operation unit 107, the information indicating the user's selection of the output destination of the processing results (ACT 110).

The control unit 105 performs output processing according to the information of the selected output destination acquired in ACT 110 (ACT 111).

The processings for ACT 101 to ACT 111 described above are achieved by executing a program stored in the storage unit 106 on the processor 109.

Moreover, a program to cause the computer constituting the image processing apparatus to execute each of the above operations can be provided as an image processing program. In the embodiment, as an example, the program to realize the functions that embodies the invention is recorded in the storage area provided within the apparatus. However, the provision of the program is not limited to this example. A similar program may be downloaded to the apparatus from a network or a similar program stored in a computer-readable recording medium may be installed in the apparatus. The recording medium may be in any form as long as the recording medium can store a program and can be read by a computer. Specifically, the recording medium may be, for example, an internal storage device installed within a computer such as ROM or RAM, a portable storage medium such as CD-ROM, flexible disk, DVD disk, magneto-optical disk or IC card, a database holding a computer program, another computer and its database, a transmission medium on a communication channel, and so on. The functions acquired in advance by installation or downloading may be realized in cooperation with the OS (operating system) within the apparatus.

A part of the program or the entire program may be made up of execution modules that are dynamically generated.

As a matter of course, at least apart of the various kinds of processing realized by allowing the processor 109 to execute the program in each of the embodiments can be executed in a circuit-based manner with the ASIC 111.

With the technique that is described in this specification, the final output destination can be decided on the basis of a content of an intermediate output that is acquired by the execution of image processing with the final output destination unspecified. Therefore, even when an unpredicted intermediate output is produced, a different final output destination can be decided without redoing the input, for example, scanning, from the beginning.

Thus, the user need not waste time and the occupying time of the image processing apparatus is reduced. Therefore, the apparatus can be effectively shared.

As described above in detail, with the technique that is described in this specification, a technique that enables selection of an output method in consideration of the output result in the case of processing image data and outputting the processed image data by one of plural output methods can be provided.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the spirit of the inventions. The accompanying claims and their equivalents are intended to cover such forms or modifications as would fall within the scope and spirit of the inventions.

What is claimed is:

1. An image processing apparatus comprising:
a data acquisition unit which acquires image data as a processing target;
an image processing unit which carries out image processing with a processing content based on setting information, to the image data;
plural output processing units which output the image data processed by the image processing unit, by different output methods from each other;
a setting information acquisition unit which acquires the setting information;
a determination unit which determines an output method that is selectable for the image data to which the processing with the setting content indicated by the setting information acquired by the setting information acquisition unit is carried out, of the plural output methods used by the plural output processing units; and
a selection candidate display unit which displays a list of information indicating the output method that is determined as selectable by the determination unit.

2. The apparatus of claim 1, further comprising:
a selection information acquisition unit which acquires selection information indicating which output method is selected from the information indicating the output methods displayed in the list by the selection candidate display unit, on the basis of an operation input from a user; and
an output control unit which causes the output processing unit corresponding to the selected output method indicated by the selection information acquired by the selection information acquisition unit, to output the image data processed by the image processing unit.

3. The apparatus of claim 2, further comprising an image input request unit which request input of the image data after the selection information is acquired by the selection information acquisition unit.

4. The apparatus of claim 1, further comprising:
a selection information acquisition unit which acquires selection information indicating which output method is selected in accordance with an operation input by a user, from the output methods displayed in the list by the selection candidate display unit;
a preview image generation unit which generates a preview image by simulating an output result in the case of outputting the image data to which the processing with the setting content indicated by the acquired setting information is carried out, by the output method indicated by the selection information acquired by the selection information acquisition unit; and
a preview image display unit which displays the preview image generated by the preview image generation unit.

5. The apparatus of claim 1, wherein the preview image generation unit generates image data in a processing state prior to a final processing state where the image data is outputted by the output method indicated by the selection information acquired by the selection information acquisition unit, as a preview image.

6. The apparatus of claim 1, wherein when the setting information acquired by the setting information acquisition unit prescribes a data volume of the image data to which the processing with the content indicated by the setting information is carried out, the determination unit determines an output method by which an output can be made in the data volume of the image data to which the processing with the content indicated by the setting information is carried out.

7. The apparatus of claim 1, wherein the output method is at least one of print, facsimile transmission, email transmission, data transmission by FTP, and data saving into a predetermined storage area.

8. An image processing method in an image processing apparatus comprising a data acquisition unit which acquires image data as a processing target, an image processing unit which carries out image processing with a processing content based on setting information, to the image data, and plural output processing units which output the image data processed by the image processing unit, by different output methods from each other, the method comprising:
acquiring the setting information;
determining an output method that is selectable for the image data to which the processing with the setting content indicated by the acquired setting information is carried out, of the plural output methods used by the plural output processing units; and
displaying a list of information indicating the output method that is determined as selectable.

9. The method of claim 8, further comprising:
acquiring selection information indicating which output method is selected from the information indicating the output methods displayed in the list, on the basis of an operation input from a user; and
causing the output processing unit corresponding to the selected output method indicated by the acquired selection information, to output the image data processed by the image processing unit.

10. The method of claim 9, further comprising requesting input of the image data after the selection information is acquired.

11. The method of claim 8, further comprising:
acquiring selection information indicating which output method is selected in accordance with an operation input by a user, from the output methods displayed in the list;
generating a preview image by simulating an output result in the case of outputting the image data to which the processing with the setting content indicated by the acquired setting information is carried out, by the output method indicated by the acquired selection information; and
displaying the generated preview image.

12. The method of claim 8, wherein image data in a processing state prior to a final processing state where the image data is outputted by the output method indicated by the acquired selection information is generated as a preview image.

13. The method of claim 8, wherein when the acquired setting information prescribes a data volume of the image data to which the processing with the content indicated by the setting information is carried out, an output method by which an output can be made in the data volume of the image data to which the processing with the content indicated by the setting information is carried out, is determined.

14. The method of claim 8, wherein the output method is at least one of print, facsimile transmission, email transmission, data transmission by FTP, and data saving into a predetermined storage area.
